(19) United States
(12) Patent Application Publication
(10) Pub. No.: US 2026/0176206 A1
(43) Pub. Date: Jun. 25, 2026

(54) MAGNESIUM PHOSPHATE-BASED CEMENT GROUTING MATERIAL, PREPARATION METHOD THEREFOR AND USE THEREOF

(71) Applicant: Wuhan University of Technology, Wuhan (CN)

(72) Inventors: Yunpeng Liu, Wuhan (CN); Guoshun Liu, Wuhan (CN); Fazhou Wang, Wuhan (CN); Shuguang Hu, Wuhan (CN)

(21) Appl. No.: 19/423,081

(22) Filed: Dec. 17, 2025

(30) Foreign Application Priority Data
Dec. 25, 2024 (CN) 2024119271634

(51) Int. Cl. C04B 28/34; C04B 14/10; C04B 24/26; C04B 24/38; C04B 103/00; C04B 103/30; C04B 103/50; C04B 111/70

(52) U.S. Cl. CPC C04B 28/34; C04B 14/104; C04B 24/2641; C04B 24/383; C04B 2103/0051; C04B 2103/302; C04B 2103/50; C04B 2111/70

(57) ABSTRACT

Disclosed is a magnesium phosphate-based cement grouting material, a preparation method therefor and use thereof. Raw materials of the magnesium phosphate-based cement grouting material include a component A and a component B; the component A includes the following raw materials in parts by weight: 140-200 parts of calcined magnesium oxide, 0-30 parts of bentonite, 0.2-0.5 part of hydroxypropyl methyl cellulose, 1-10 parts of additive and 70-140 parts of water; the component B includes the following raw materials in parts by weight: 70-100 parts of first dihydric phosphate, 20-50 parts of pretreated polymer water-absorbent resin, 0.5-2 parts of sodium polyacrylate and 30-70 parts of water. The magnesium phosphate-based cement grouting material has the advantages of low shrinkage, short and adjustable setting time, high compressive strength, simple construction, low cost, environmental friendliness, good grout injectivity, good resistance to water dispersibility and good durability in a long-term soaking environment.

### TECHNICAL FIELD

The present disclosure relates to the technical field of grouting materials, and particularly relates to a magnesium phosphate-based cement grouting material, a preparation method therefor and use thereof.

### BACKGROUND

With the rapid development of economy and shortage of land resources in China, underground engineering construction is rapidly developed. However, the underground engineering construction represented by tunnels and stations are easy to leak water, which harms the safety, stability and durability of buildings (structures) and influences the normal use function, thereby bringing huge operation and maintenance cost. Underground engineering leakage can be divided into slow leakage, fast leakage, water leakage and water gushing according to water flow. The harm of the water leakage, particularly strong leakage, is the most serious. In the engineering, epoxy resin, cement and cement-sodium silicate materials and the like that are quickly cured to form a gel structure are generally used for grouting and plugging. However, the epoxy resin material has high cost, poor environmental friendliness and poor water scouring resistance; the common cement-based grouting material has long setting time, poor resistance to water dispersibility and more complex construction; and the cement-sodium silicate materials have short gelling time and high strength, but have poor durability in a long-term soaking environment.

Chinese patent CN 117865593 A discloses a novel green anti-dispersion synchronous grouting material for a water-rich stratum, and a preparation method therefor. The grouting material includes the following components in parts by weight: Portland cement, fine sand, fly ash, hydroxypropyl methyl cellulose, 2-ethylhexyl phosphate-2-ethylhexyl ester, sodium tripolyphosphate, sodium dodecyl sulfate, a polycarboxylic acid superplasticizer or a naphthalene superplasticizer, polyacrylamide, formic acid, bentonite and water. But the product has relatively long setting time and the initial setting time of 5 hours, and thus is not suitably used as a quick emergency repair material for cracks leaking water. Chinese patent CN 108002802 A discloses a magnesium phosphate-based cement grouting material and a preparation method therefor. The grouting material includes the following components in parts by weight: a composite magnesium compound, a composite retarder, a water reducing agent, an acid-base buffering agent, a composite stabilizer, a composite surfactant, a phosphate and a defoaming agent. However, the material has a small water-cement ratio, and thus is not suitable for grouting and water plugging working condition of micro cracks.

Therefore, it is of very important significance to develop a material for repairing cracks leaking water which has short and adjustable setting time, high compressive strength, simple construction, low cost, environmental friendliness, good grout injectivity, good resistance to water dispersibility and good durability in a long-term soaking environment.

### SUMMARY

The present disclosure aims to overcome the above-mentioned technical shortages and provides a magnesium phosphate-based cement grouting material, a preparation method therefor and use thereof to solve the technical problems in the prior art that an inorganic grouting material has long setting time, poor resistance to water dispersibility, complex construction and poor durability in a long-term soaking environment.

In a first aspect, the present disclosure provides a magnesium phosphate-based cement grouting material. Raw materials of the magnesium phosphate-based cement grouting material include a component A and a component B; the component A includes the following raw materials in parts by weight: 140-200 parts of calcined magnesium oxide, 0-30 parts of bentonite, 0.2-0.5 part of hydroxypropyl methyl cellulose, 1-10 parts of additive and 70-140 parts of water; the component B includes the following raw materials in parts by weight: 70-100 parts of first dihydric phosphate, 20-50 parts of pretreated polymer water-absorbent resin, 0.5-2 parts of sodium polyacrylate and 30-70 parts of water; the pretreated polymer water-absorbent resin is obtained by soaking polymer water-absorbent resin in an aqueous solution of second dihydric phosphate; and a molar ratio of magnesium to phosphorus in the calcined magnesium oxide and the first dihydric phosphate is (5.5-6.5):1.

In a second aspect, the present disclosure provides a method for preparing a magnesium phosphate-based cement grouting material, including the following steps:
uniformly mixing calcined magnesium oxide, bentonite and hydroxypropyl methyl cellulose to obtain a mixed powder; uniformly mixing an additive with water to obtain a mixed solution; and uniformly mixing the mixed powder with the mixed solution to obtain a component A; and
uniformly mixing first dihydric phosphate, sodium polyacrylate, a pretreated polymer water-absorbent resin and water to obtain a component B.

In a third aspect, the present disclosure provides use of a magnesium phosphate-based cement grouting material in plugging cracks leaking water.

Compared with the prior art, the present disclosure has the following beneficial effects:

The magnesium phosphate-based cement grouting material of the present disclosure has the characteristics of low shrinkage, short and adjustable setting time, high compressive strength, simple construction, low cost, environmental friendliness, good grout injectivity, good resistance to water dispersibility and good durability in a long-term soaking environment.

### DETAILED DESCRIPTION OF THE EMBODIMENTS

To make the objective, technical solutions and advantages of the present disclosure clearer and more comprehensible, the present disclosure will be further described below in detail in conjunction with embodiments. It should be understood that specific embodiments described herein are merely intended to explain but not to limit the present disclosure.

In a first aspect, the present disclosure provides a magnesium phosphate-based cement grouting material. The raw materials of the magnesium phosphate-based cement grouting material include a component A and a component B; the component A includes the following raw materials in parts by weight: 140-200 parts of calcined magnesium oxide, 0-30 parts of bentonite, 0.2-0.5 part of hydroxypropyl methyl cellulose, 1-10 parts of additive and 70-140 parts of water; the component B includes the following raw materials in parts by weight: 70-100 parts of first dihydric phosphate, 20-50 parts of pretreated polymer water-absorbent resin, 0.5-2 parts of sodium polyacrylate and 30-70 parts of water.

The main raw materials used in the present disclosure have the following functions:

Magnesium oxide and ammonium dihydrogen phosphate: the two substances react to generate cementing-phase struvite, and the struvite and heavily calcined magnesium oxide (functioning as an aggregate) jointly provide strength; and magnesium oxide is both a raw material for producing the cementing-phase struvite and an aggregate of magnesium phosphate cement (MPC). The lightly calcined magnesium oxide with a low calcination temperature provides a relatively fast reaction rate, and the heavily calcined magnesium oxide with a high calcination temperature acts as the aggregate.

Bentonite and hydroxypropyl methyl cellulose: they can improve the viscosity and stability of the component A, thereby avoiding sedimentation.

Pretreated polymer water-absorbent resin (SAP): it is obtained by adsorbing a dihydrogen phosphate solution onto a polymer water-absorbent resin in advance. The pretreated SAP can be used to improve the proportion of actual dihydric phosphate and play a similar internal curing effect. The dihydric phosphate reacts with magnesium oxide in a later period of slow release to generate struvite to fill gaps. The heat released by the reaction of magnesium oxide and dihydric phosphate at an early period can enable the pretreated polymer water-absorbent resin to release dihydric phosphate to further participate in the reaction, such that the total reaction time is prolonged and the reaction is relatively mild. The polymer water-absorbent resin releasing the dihydrogen phosphate solution at the later period can absorb a small amount of water immersed into the grouting material to a certain extent and expand to fill the gaps, such that water transmission is hindered and the water erosion resistance of the material is improved.

Sodium polyacrylate: in an aqueous solution, the molecular chains of sodium polyacrylate can form a net structure, and these molecular chains have a certain crosslinking effect to increase the viscosity and improve the resistance to water dispersibility; and meanwhile, the molecular chains contain hydrophilic carboxyl functional groups, and the carboxyl groups can generate carboxylate anions after alkali neutralization, such that the resistance to acid and alkali is good.

In this embodiment, the first dihydric phosphate is at least one of ammonium dihydrogen phosphate, potassium dihydrogen phosphate and sodium dihydrogen phosphate, preferably ammonium dihydrogen phosphate. Among the above-mentioned dihydrogen phosphates, the ammonium dihydrogen phosphate reacts with magnesium oxide most rapidly, thus the grouting material has the highest early strength, which can satisfy the requirements of rapid plugging and higher early strength. Therefore, ammonium dihydrogen phosphate is preferred.

In this embodiment, the pretreated polymer water-absorbent resin is obtained by soaking a polymer water-absorbent resin in an aqueous solution of second dihydric phosphate.

The particle size of the polymer water-absorbent resin is 200-500 meshes, the water absorption rate in pure water is 100-1000 times, and the liquid absorption rate in a 2.5 mol/L dihydrogen phosphate solution is 1-50 times.

The second dihydric phosphate is at least one of ammonium dihydrogen phosphate, potassium dihydrogen phosphate and sodium dihydrogen phosphate. Among the above-mentioned dihydrogen phosphates, the ammonium dihydrogen phosphate reacts with magnesium oxide most rapidly, thus the grouting material has the highest early strength, which can satisfy the requirements of rapid plugging and higher early strength.

Therefore, ammonium dihydrogen phosphate is preferred.

The concentration of the aqueous solution of the second dihydric phosphate is 1-5 mol/L, further 2.5 mol/L.

The solid-liquid ratio of the polymer water-absorbent resin to the aqueous solution of a second dihydric phosphate is 1:(50-500), further 1:100.

The soaking is performed at a temperature of 20-30° C. for 10-60 min, further 10 min.

The pretreated polymer water-absorbent resin is obtained by soaking the polymer water-absorbent resin in the aqueous solution of the second dihydric phosphate.

In this embodiment, the magnesium oxide is at least one of the lightly calcined magnesium oxide and the heavily calcined magnesium oxide.

Preferably, the lightly calcined magnesium oxide is calcined at a temperature of 900-1000° C., further 950° C.; and the heavily calcined magnesium oxide is calcined at a temperature of 1600-1700° C., further 1650° C.

Preferably, the calcined magnesium oxide is prepared by compounding the lightly calcined magnesium oxide and the heavily calcined magnesium oxide. Generally, the lower the calcination temperature, the higher the activity of the magnesium oxide and the faster it participates in the reaction; the higher the calcination temperature, the higher the strength of the magnesium oxide, the magnesium oxide acts as an aggregate and can provide higher strength. In the compounding system of the present disclosure, the lightly calcined magnesium oxide reacts firstly and provides strength more quickly. After the lightly calcined magnesium oxide reacts completely, the heavily calcined magnesium oxide continues to react. After the dihydric phosphate reacts completely, the rest magnesium oxide has a relatively high calcination temperature and can provide higher strength for the matrix. The compounding of the two substances can realize quick plugging and simultaneously achieve relatively high strength.

More preferably, a mass ratio of the lightly calcined magnesium oxide to the heavily calcined magnesium oxide is (2-4):1, more preferably, 3:1.

In this embodiment, the particle size of the bentonite is 100-300 meshes, further 200 meshes.

In this embodiment, the viscosity of the hydroxypropyl methyl cellulose is 100000-300000 mPa·s, further 200000 mPa·s.

In this embodiment, the additive includes at least one of a defoaming agent and a water reducing agent.

The defoaming agent is an organosilicone defoaming agent and has the solid content of 5%-20%, further 10%.

The water reducing agent is a highly efficient polycarboxylic acid water reducing agent and has the solid content of 30%-50%, further 40%.

In this embodiment, a molar ratio of magnesium to phosphorus in calcined magnesium oxide and first dihydric phosphate is (5.5-6.5):1, further 6:1.

In this embodiment, in the magnesium phosphate-based cement grouting material, the component A includes the following raw materials in parts by weight: 170-190 parts of calcined magnesium oxide, 15-20 parts of bentonite, 0.3-0.4 part of hydroxypropyl methyl cellulose, 3-6 parts of additive and 100-120 parts of water; and the component B includes the following raw materials in parts by weight: 80-90 parts of first dihydric phosphate, 30-40 parts of pretreated polymer water-absorbent resin, 0.8-1.2 parts of sodium polyacrylate and 40-60 parts of water.

In a second aspect, the present disclosure provides a method for preparing a magnesium phosphate-based cement grouting material, including the following steps:
S1, uniformly mixing calcined magnesium oxide, bentonite and hydroxypropyl methyl cellulose to obtain a mixed powder; uniformly mixing an additive with water to obtain a mixed solution; and uniformly mixing the mixed powder with the mixed solution to obtain a component A; and
S2, uniformly mixing first dihydric phosphate, sodium polyacrylate, a pretreated polymer water-absorbent resin and water to obtain a component B.

In the present disclosure, the sequence of steps S1 and S2 is not limited, and can be selected by those skilled in the art according to actual situations.

In this embodiment, the calcined magnesium oxide, the bentonite and the hydroxypropyl methyl cellulose are uniformly mixed by stirring for 20-60 s.

In this embodiment, the additive and the water are uniformly mixed by stirring for 20-60 s.

In this embodiment, the mixed powder and mixed solution are uniformly mixed by stirring for 1-5 min.

In this embodiment, the first dihydric phosphate, the sodium polyacrylate, the pretreated polymer water-absorbent resin and the water are uniformly mixed by stirring for 0.5-2 min.

In a third aspect, the present disclosure provides use of a magnesium phosphate-based cement grouting material in plugging cracks leaking water, preferably plugging cracks strongly leaking water.

In this embodiment, the above-mentioned use includes:
uniformly mixing the component A with the component B, and injecting the mixture into cracks leaking water for plugging.

Further, the process of uniformly mixing the component A with the component B includes: loading the component A and the component B into a slurry storage bin of a double-liquid grouting machine, and uniformly mixing the component A with the component B through the double-liquid grouting machine.

In order to avoid redundancy, in the following examples and comparative examples of the present disclosure, some raw materials are summarized as follows:
magnesium oxide: the lightly calcined magnesium oxide and the heavily calcined magnesium oxide are both provided by Dashiqiao Jubo High-Temperature Refractory Material Business Department; the lightly calcined magnesium oxide has the calcination temperature of 950° C., the specific surface area of 1.62 m²/g and the purity of 85.98%; and the heavily calcined magnesium oxide has the calcination temperature of 1650° C., the specific surface area of 1.35 m²/g and the purity of 89.61%. Each chemical composition is seen in Table 1.

TABLE 1
Chemical compositions of magnesium oxides/wt. %

| | MgO | SiO₂ | Al₂O₃ | CaO | Fe₂O₃ | MnO | TiO₂ | Na₂O | SO₃ |
|---|---|---|---|---|---|---|---|---|---|
| Heavily calcined | 85.981 | 5.379 | 1.659 | 2.484 | 2.171 | 0.158 | 0.047 | 0.193 | 0.288 |
| magnesium oxide | | | | | | | | | |
| Lightly calcined | 89.609 | 3.158 | 0.481 | 1.613 | 0.590 | 0.044 | 0.031 | / | 0.120 |
| magnesium oxide | | | | | | | | | |

The particle size of the bentonite is 200 meshes.

The viscosity of the hydroxypropyl methyl cellulose is 200000 mPa·s.

The defoaming agent is an organosilicone defoaming agent and has the solid content of 10%.

The water reducing agent is a highly efficient polycarboxylic acid water reducing agent and has the solid content of 40%.

The ammonium dihydrogen phosphate is analytically pure.

The pretreated polymer water-absorbent resin is obtained by the following method: pre-soaking a polymer water-absorbent resin in a 2.5 mol/L ammonium dihydrogen phosphate solution at 25° C. for 10 min, wherein a solid-liquid ratio is 1:100; the particle size of the polymer water-absorbent resin is 400 meshes, the water absorption rate in pure water is 500 times, and the liquid absorption rate in the 2.5 mol/L ammonium dihydrogen phosphate solution is 8.6 times.

### Examples 1-6 and Comparative Examples 1-4

A method for preparing a magnesium phosphate-based cement grouting material provided by examples 1-6 and comparative examples 1-4 included the following steps:
(1) preparation of component A: certain amounts of calcined magnesium oxide, bentonite and hydroxypropyl methyl cellulose were weighed according to mixing ratios in Tables 2 and 3, and stirred for 30 s until the raw materials were fully mixed; certain amounts of a water reducing agent, a defoaming agent and water were weighed according to mixing ratios in Tables 2 and 3, and stirred for 30 s until the materials were fully mixed; and the powder and the liquid were mixed and stirred for 2 min to form a component A; and
(2) preparation of component B: certain amounts of ammonium dihydrogen phosphate, sodium polyacrylate, pretreated polymer water-absorbent resin (a polymer water-absorbent resin in comparative example 2) and water were weighed according to the mixing ratios of Tables 2 and 3, and stirred for 1 min until the materials were fully mixed to form a component B.

### Comparative Example 5 (Cement-Sodium Silicate System)

A method for preparing a cement-sodium silicate double-liquid grouting material included the following steps:
(1) preparation of component A: a certain amount of cement was weighed according to a mixing ratio in Table 4; certain amounts of a polycarboxylic acid water reducing agent, an organosilicone defoaming agent and water were weighed according to a mixing ratio in Table 4, and stirred for 30 s until the materials were fully mixed; and the powder and the liquid were mixed and stirred for 2 min to form a component A; and
(2) preparation of component B: certain amounts of sodium silicate (Baume degree 40° Bé) and water were weighed according to a mixing ratio in Table 4, and stirred for 2 min to form a component B.

TABLE 2
Formulations of grouting materials used in examples 1-6 and comparative examples 1-4 (in parts by weight)

| | | | | | | | Component B | | | | |
|---|---|---|---|---|---|---|---|---|---|---|---|
| | Component A | | | | | | | Pretreated | | | |
| | | | Hydroxy- | | | | | polymer | Polymer | | |
| | Calcined | | propyl- | Water | | | Ammonium | water- | water- | Sodium | |
| | magnesium | | methyl | reducing | Defoaming | | dihydrogen | absorbent | absorbent | poly- | |
| No. | oxide | Bentonite | cellulose | agent | agent | Water | phosphate | resin | resin | acrylate | Water |
| Example 1 | 180 | 18 | 0.36 | 4.5 | 0.18 | 108 | 85.63 | 36 | / | 1 | 51.38 |
| Example 2 | 180 | 18 | 0.36 | 4.5 | 0.18 | 108 | 85.63 | 36 | / | 1 | 51.38 |
| Example 3 | 180 | 18 | 0.36 | 4.5 | 0.18 | 108 | 85.63 | 36 | / | 1 | 51.38 |
| Example 4 | 180 | 18 | 0.36 | 4.5 | 0.18 | 108 | 85.63 | 36 | / | 1 | 51.38 |
| Example 5 | 180 | 18 | 0.36 | 4.5 | 0.18 | 108 | 85.63 | 36 | / | 1 | 51.38 |
| Example 6 | 180 | / | 0.36 | 4.5 | 0.18 | 108 | 85.63 | 36 | / | 1 | 51.38 |
| Comparative | 180 | 18 | 0.36 | 4.5 | 0.18 | 108 | 85.63 | / | / | 1 | 51.38 |
| example 1 | | | | | | | | | | | |
| Comparative | 180 | 18 | 0.36 | 4.5 | 0.18 | 108 | 97.22 | / | 3.75 | 1 | 51.38 |
| example 2 | | | | | | | | | | | |
| Comparative | 180 | 18 | 0.36 | 4.5 | 0.18 | 108 | 85.63 | 36 | / | / | 51.38 |
| example 3 | | | | | | | | | | | |
| Comparative | 180 | / | 0.36 | 4.5 | 0.18 | 108 | 85.63 | / | / | / | 51.38 |
| example 4 | | | | | | | | | | | |

TABLE 3
Formulations of calcined magnesium oxides used in examples
1-6 and comparative examples 1-4 (in parts by weight)

| | Light-to- | | |
|---|---|---|---|
| | heavy ratio | 950° C. | 1650° C. |
| Example 1 | 1:0 | 180 | 0 |
| Example 2 | 2:1 | 120 | 60 |
| Example 3 | 3:1 | 135 | 45 |
| Example 4 | 4:1 | 144 | 36 |
| Example 5 | 0:1 | 0 | 180 |
| Example 6 | 3:1 | 135 | 45 |
| Comparative | 3:1 | 135 | 45 |
| example 1 | | | |
| Comparative | 3:1 | 135 | 45 |
| example 2 | | | |
| Comparative | 3:1 | 135 | 45 |
| example 3 | | | |
| Comparative | 3:1 | 135 | 45 |
| example 4 | | | |

Examples 1-5 verified the influence of the ratios of the calcined magnesium oxides on the novel magnesium phosphate-based cement grouting plugging material. Example 6 and comparative examples 1-4 respectively verified the influence of the bentonite, the polymer water-absorbent resin and the sodium polyacrylate on the novel magnesium phosphate-based cement grouting plugging material.

TABLE 4
Formulation of grouting material used in comparative
example 5 (in parts by weight)

| Component A | | | | Component B | |
|---|---|---|---|---|---|
| | Water | | | Sodium | |
| | reducing | Defoaming | | silicate | |
| Cement | agent | agent | Water | solution | Water |
| 160 | 2.4 | 0.16 | 96 | 132.4 | 96 |

### Performance Test

The component A and the component B of the grouting material were uniformly mixed. The mixture was injected into a mold of 40*40*160 mm by using two modes such as air forming and underwater forming, demolded after 0.5 h, and respectively cured in air and water. The curing in air was performed at 20±2° C. and under the relative humidity of ≥95%. The curing in water was performed at 20±2° C. The compressive strength was measured and a water-land strength ratio was calculated after 28 days.

The underwater calculus rate HR is a ratio of the volume of underwater formed calculus bodies to the initial volume of a grout. 100 ml of a freshly mixed grout was drawn up with a syringe and injected into a vessel containing 100 ml of water, and after 3 h, the volume of water and non-calculus grout was measured. The calculation formula of the calculus rate HR of the sample was as follows:

$$HR = ( {V}_{grout} + {V}_{water} - {V}_{0} ) / {V}_{grout} \times 100 \% \qquad ( 1 )$$

V_{grout}—the volume of the freshly stirred grout, and 100 ml was taken;
V_{water}—the volume of the water injected, and 100 ml was taken; and
V₀—the volume of the remaining water and non-calculus grout after 3 h.

The retention rate of grout resistant to moving water scouring was tested by using a grout scouring resistance test device built by a laboratory. A moving water trough had the length of 200 cm, the width of 15 cm and the height of 5 cm. The water flow rate was controlled to be 0.4 m/s by adjusting a water inlet valve. 500 g of the grout was injected each time, recorded as M₀, and directly poured onto a detection plate at a position of 20 cm of a water inlet to simulate the grouting process. The speed was kept constant during the injection process. When clean water continuously flew out of a water outlet, the mass of the remaining grout on the detection plate was measured and recorded as Mi, and the grout retention ratio (GRR) was calculated. The calculation formula of the retention rate of grout resistant to moving water scouring was as follows:

$$GRR = {M}_{1} / {M}_{0} \times 100 \% \qquad ( 2 )$$

The test results were seen in Table 5.

TABLE 5
Results of performance test in examples 1-6 and comparative examples 1-5

| | | | | | Retention | |
|---|---|---|---|---|---|---|
| | | | | | rate of | |
| | | | 28 d | 28 d | resistance | |
| | Setting | 3 h | underwater | water- | to moving | |
| | time | underwater | compressive | land | water | |
| | in air | calculus | strength | strength | scouring | |
| | (s) | rate (%) | (MPa) | ratio | (%) | Notes |
| Example 1 | 15 | 115 | 4.8 | 0.89 | 84 | Pure lightly |
| | | | | | | calcined |
| Example 2 | 34 | 108 | 5.5 | 0.86 | 83 | Light-to-heavy |
| | | | | | | ratio of 2:1 |
| Example 3 | 25 | 110 | 6 | 0.95 | 85 | Light-to-heavy |
| | | | | | | ratio of 3:1 |
| Example 4 | 19 | 113 | 5 | 0.88 | 83 | Light-to-heavy |
| | | | | | | ratio of 4:1 |
| Example 5 | 40 | 101 | 4.8 | 0.80 | 78 | Pure heavily |
| | | | | | | calcined |
| Example 6 | 23 | 106 | 4 | 0.83 | 78 | Free of |
| | | | | | | bentonite |
| Comparative | 23 | 105 | 3.5 | 0.78 | 70 | Free of |
| example 1 | | | | | | pretreated SAP |
| Comparative | 20 | 109 | 5.7 | 0.80 | 75 | Pretreated |
| example 2 | | | | | | SAP was |
| | | | | | | replaced with |
| | | | | | | SAP |
| Comparative | 22 | 105 | 3.2 | 0.67 | 30 | Free of sodium |
| example 3 | | | | | | polyacrylate |
| Comparative | 19 | 98 | 2.8 | 0.55 | 20 | Free of |
| example 4 | | | | | | bentonite, SAP |
| | | | | | | and sodium |
| | | | | | | polyacrylate |
| Comparative | 60 | 95 | 4.3 | 0.75 | 78 | Cement-sodium |
| example 5 | | | | | | silicate |

Referring to Table 5, it can be seen from Table 5 that compared with comparative example 5, the magnesium phosphate-based cement grouting materials prepared in examples 1-6 of the present disclosure all had lower setting time, a greater 3 h underwater calculus rate, a higher 28d underwater compressive strength, a 28d water-land strength ratio, and a comparable or even greater retention rate of resistance to moving water scouring, indicating that the magnesium phosphate-based cement grouting material of the present disclosure has the characteristics of low shrinkage, short and adjustable setting time, high compressive strength, simple construction, low cost, environmental friendliness, good grout injectivity, high resistance to permeability, good resistance to water dispersibility and good durability in a long-term soaking environment.

Examples 1-5 mainly demonstrated the influence of the calcined magnesium oxide on the novel magnesium phosphate-based cement grouting plugging material. It can be seen from examples 1-5 that along with the increase of the light-to-heavy ratio, the setting time was gradually reduced, the 3 h underwater calculus rate was gradually increased, but the 28d underwater compressive strength, the 28d water-land strength ratio and the retention rate of resistance to moving water scouring all showed the trend of increasing firstly and then decreasing.

Compared with example 3, the bentonite was not added in example 6. The 3 h underwater calculus rate, the 28d underwater compressive strength, the 28d water-land strength ratio and the retention rate of resistance to moving water scouring all decreased, but were obviously superior to the those of the existing cement-sodium silicate system.

Compared with example 3, the pretreated polymer water-absorbent resin was not added in comparative example 1. The 3 h underwater calculus rate, the 28d underwater compressive strength, the 28d water-land strength ratio and the retention rate of resistance to moving water scouring all decreased, but were obviously superior to the those of the existing cement-sodium silicate system.

Compared with example 3, in comparative example 2, the pretreated polymer water-absorbent resin was replaced by the polymer water-absorbent resin and the content of the dihydric phosphate was increased. The dihydric phosphate in the system directly reacted with the magnesium oxide, such that the setting time was shortened, the reaction rate was too high, the sample showed cracks, and the 28d underwater compressive strength, the 28d water-land strength ratio and the ability of resistance to moving water scouring were obviously decreased.

Compared with example 3, the sodium polyacrylate was not added in comparative example 3. The 3 h underwater calculus rate, the 28d underwater compressive strength, the 28d water-land strength ratio and the ability of resistance to moving water scouring all obviously decreased, and the water-land strength ratio and the ability of resistance to moving water scouring were even inferior to those of the existing cement-sodium silicate system.

Compared with example 3, the bentonite, the SAP and the sodium polyacrylate were not added in comparative example 4. Although the setting time was decreased, the 3 h underwater calculus rate, the 28d underwater compressive strength, the 28d water-land strength ratio and the ability of resistance to moving water scouring all obviously decreased, and the water-land strength ratio and the ability of resistance to moving water scouring were even inferior to those of the existing cement-sodium silicate system.

Compared with the prior art, the present disclosure mainly has the following beneficial effects:
(1) The grouting material has high early strength, good later strength development, short and adjustable setting time and excellent resistance to water dispersibility, can rapidly repair cracks and has a strong bonding property.
(2) The raw materials are good in stability, convenient for storage and environmental-friendly, and have a simple construction process.
(3) Different calcined magnesium oxides were compounded for use, such that the magnesium oxides with different calcining temperatures reacted in stages in the early period (within minutes), can quickly participate in the reaction to generate hydration products to provide initial strength, and can prevent the cracking of a grouting material matrix caused by a large amount of heat release due to the excessively severe degree of the initial reaction.
(4) The bentonite and the lightly calcined magnesium oxide provide higher water absorption and expansion property for the magnesium phosphate cement; and the pre-treated SAP can reduce the reaction rate and improve the water resistance and resistance to water dispersibility of the material. The water absorption can ensure that the grout absorbs part of water in the cracks leaking water in the grouting process, reduce the grouting difficulty, and achieve a better grouting result; and the expansion property can ensure that the 3 h underwater calculus rate of the material can reach 100% or more to prevent re-generation of cracks caused by shrinkage.

The foregoing descriptions are implementation manners of the present disclosure, but are not intended to limit the protection scope of the present disclosure. Any other corresponding changes and modifications made according to the technical idea of the present disclosure shall fall within the protection scope of the claims of the present disclosure.

What is claimed is:

1. A magnesium phosphate-based cement grouting material, wherein raw materials of the magnesium phosphate-based cement grouting material comprise a component A and a component B; wherein, the component A comprises the following raw materials in parts by weight: 140-200 parts of calcined magnesium oxide, 0-30 parts of bentonite, 0.2-0.5 part of hydroxypropyl methyl cellulose, 1-10 parts of additive and 70-140 parts of water; the component B comprises the following raw materials in parts by weight: 70-100 parts of first dihydric phosphate, 20-50 parts of pretreated polymer water-absorbent resin, 0.5-2 parts of sodium polyacrylate and 30-70 parts of water; the calcined magnesium oxide is prepared by compounding lightly calcined magnesium oxide and heavily calcined magnesium oxide in a mass ratio of (2-4):1; the additive comprises at least one of a defoaming agent and a water reducing agent; the pretreated polymer water-absorbent resin is obtained by soaking a polymer water-absorbent resin in an aqueous solution of second dihydric phosphate; the first dihydric phosphate and the second dihydric phosphate are both at least one of ammonium dihydrogen phosphate, potassium dihydrogen phosphate and sodium dihydrogen phosphate; and a molar ratio of magnesium to phosphorus in the calcined magnesium oxide and the first dihydric phosphate is (5.5-6.5):1.

2. The magnesium phosphate-based cement grouting material according to claim 1, wherein the lightly calcined magnesium oxide is calcined at a temperature of 900-1000° C.; and
the heavily calcined magnesium oxide is calcined at a temperature of 1600-1700° C.

3. The magnesium phosphate-based cement grouting material according to claim 1, wherein a mass ratio of the lightly calcined magnesium oxide to the heavily calcined magnesium oxide is 3:1.

4. The magnesium phosphate-based cement grouting material according to claim 1, wherein a particle size of the polymer water-absorbent resin is 200-500 meshes, a water absorption rate in pure water is 100-1000 times, and a liquid absorption rate in a 2.5 mol/L dihydrogen phosphate solution is 1-50 times; and/or
a concentration of the aqueous solution of the second dihydric phosphate is 1-5 mol/L; and/or
a solid-liquid ratio of the polymer water-absorbent resin to the aqueous solution of the second dihydric phosphate is 1:(50-500); and/or
the soaking is performed at a temperature of 20-30° C. for 10-60 min.

5. The magnesium phosphate-based cement grouting material according to claim 1, wherein a particle size of the bentonite is 100-300 meshes; and/or
a viscosity of the hydroxypropyl methyl cellulose is 100000-300000 mPa·s.

6. The magnesium phosphate-based cement grouting material according to claim 1, wherein in the magnesium phosphate-based cement grouting material, the component A comprises the following raw materials in parts by weight: 170-190 parts of calcined magnesium oxide, 15-20 parts of bentonite, 0.3-0.4 part of hydroxypropyl methyl cellulose, 3-6 parts of additive and 100-120 parts of water; and the component B comprises the following raw materials in parts by weight: 80-90 parts of first dihydric phosphate, 30-40 parts of pretreated polymer water-absorbent resin, 0.8-1.2 parts of sodium polyacrylate and 40-60 parts of water.

7. A method for preparing the magnesium phosphate-based cement grouting material according to claim 1, comprising the following steps:
uniformly mixing calcined magnesium oxide, bentonite and hydroxypropyl methyl cellulose to obtain a mixed powder; uniformly mixing an additive with water to obtain a mixed solution; and uniformly mixing the mixed powder with the mixed solution to obtain a component A; and
uniformly mixing first dihydric phosphate, sodium polyacrylate, a pretreated polymer water-absorbent resin and water to obtain a component B.

8. Use of the magnesium phosphate-based cement grouting material according to claim 1 in plugging cracks leaking water.
